(19) United States
(12) Patent Application Publication
(10) Pub. No.: US 2018/0370352 A1
(43) Pub. Date: Dec. 27, 2018

(54) SAFETY SPILL-PROOF FUEL TANK STRUCTURE

(71) Applicant: CHONGQING BAIKE DINGYU TECHNOLOGY Co., Ltd., Chongqing (CN)

(72) Inventor: Yi ZHANG, Chongqing (CN)

(73) Assignee: CHONGQING BAIKE DINGYU TECHNOLOGY Co., Ltd.

(21) Appl. No.: 15/961,754

(22) Filed: Apr. 24, 2018

(30) Foreign Application Priority Data
Jun. 21, 2017 (CN) 201720728938.4

(51) Int. Cl. B60K 15/04

(52) U.S. Cl. CPC B60K 15/04; B60K 2015/0461

(57) ABSTRACT

The safety spill-proof fuel tank structure includes a fuel tank body. The fuel tank body has an outlet tube at the bottom and an inlet tube at the top. The fuel tank body has a fixed vertical plane and a placement plane opposite to the fixed plane. The fixed plane has a fixed support. The inlet tube has a spill-proof spacer on its inner wall. There is a fuel filler used for filling fuel into the fuel tank body between the spill-proof spacer and the inner wall far away from the placement plane inside the inlet tube. When the placement plane of the fuel tank body is placed downwards, the spill-proof spacer can prevent fuel outflow from the fuel tank body and avoid wasting of fuel.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The utility model relates to the technical field of tankage facility, and, more particularly, to a safety spill-proof fuel tank structure.

### 2. Description of Related Art Including Information Disclosed Under 37 CFR 1.97 and 37 CFR 1.98

A fuel tank is an indispensible component for fuel-using equipment and is used to store the fuel required by fuel-using equipment. Usually it is fixed on fuel-using equipment, however, sometimes it has to be unloaded when necessary. According to the prior art, due to the irregular structures of some fuel tanks, sometimes it's impossible to vertically place the unloaded fuel tanks, or it's necessary to lay them down to the ground. In actual operations, an unloaded fuel tank may still contain some fuel inside, and, when it is laid down to the ground, the fuel inside may flow out of the fuel tank via the fuel inlet and be wasted. In this case, to drain the fuel out of the fuel tank, an extra fuel container will have to be provided; what's more, the weights of the fuel tank and the fuel inside will inevitably increase operators' labor intensity, not to mention that the reinstallation of the fuel tank and the refilling of fuel will also be very time-consuming and labor-intensive.

### BRIEF SUMMARY OF THE INVENTION

The technical problem to be solved by the utility model is to provide a simple safety spill-proof fuel tank structure that can be directly placed after being unloaded, without causing any wasting of fuel.

The utility model proposes the following technical scheme to solve the above technical problem: A safety spill-proof fuel tank structure, including fuel tank body, wherein the said fuel tank body has an outlet tube at the bottom; the said fuel tank body has an inlet tube at the top; the said fuel tank body has a fixed vertical plane; the said fuel tank body has a placement plane opposite to the said fixed plane; the said fixed plane is designed with a fixed support, used to fix the said fuel tank on the fuel-using equipment; the said inlet tube is designed inside with a spill-proof spacer on its inner wall close to the said placement plane; there is a fuel filler used for filling fuel into the said fuel tank body between the said spill-proof spacer and the inner wall far away from the said placement plane inside the said inlet tube.

The utility model has the following beneficial effects: The inlet tube is designed inside with a spill-proof spacer, and between one side of the spill-proof spacer and the inner wall far away from the placement plane inside the inlet tube there is a fuel filler used for filling fuel into the fuel tank body; when the placement plane of the fuel tank body is placed downwards, the spill-proof spacer can prevent fuel outflow from the fuel tank body and avoid wasting of fuel.

Based on the above technical scheme, the utility model can also be improved as follows.

Furthermore, the said inlet tube is set to incline towards the direction far away from the said placement plane.

The beneficial effect of adopting the above further scheme is that: The top of the inlet tube is set to incline towards the direction far away from the placement plane, so that, when the placement plane of the fuel tank body is placed downwards, the level of the fuel filler of the inlet tube will be increased to further avoid fuel outflow.

Furthermore, the said spill-proof spacer faces one side of the said fuel filler, and is set to incline towards the end where the said inlet tube links up with the said fuel tank body.

The beneficial effect of adopting the above further scheme is that: Under the inclined setting of the inlet tube, the spill-proof spacer faces one side of the fuel filler and is set to incline towards the end where the inlet tube links up with the fuel tank body. In this way, without influencing fuel filling via the fuel filler, when the placement plane is placed downwards, the level of the fuel filler of the fuel tank body will be increased to further avoid fuel outflow.

Furthermore, the vertical projection of the said fuel filler is outside of the vertical projection of the said fuel tank body, and far away from the vertical projection of the said placement plane.

The beneficial effect of adopting the above further scheme is that: Given that the vertical projection of the fuel filler is outside of the vertical projection of the fuel tank body and far away from that of the placement plane, when the placement plane of the fuel tank body is placed downwards, fuel would not flow out of the fuel filler even if the fuel tank body is filled up with fuel.

Furthermore, the said inlet tube has a circular cross-section; the sides of the said spill-proof spacer include arc-shaped side and straight side; the said arc-shaped side is fixed on the inner wall of the said inlet tube; the gap between the said straight side and the inner wall of the said inlet tube forms the said fuel filler.

The beneficial effect of adopting the above further scheme is that: The inlet tube has a circular cross-section, and the unit-mode side of the spill-proof spacer can be perfectly sealed and linked up with the inner wall of the inlet tube.

Furthermore, the said spill-proof spacer and the said inlet tube constitute an integrated structure.

The beneficial effect of adopting the above further scheme is that: The integration of the spill-proof spacer and the inlet tube not only makes convenience for manufacturing of the inlet tube, but also avoids the failure of the spill-proof spacer to block fuel outflow due to looseness.

### BRIEF DESCRIPTION OF THE SEVERAL VIEWS OF THE DRAWINGS

FIG. 1 provides the schematic view of a diagram of the utility model when placed on fuel-using equipment.

FIG. 2 provides the schematic view of a diagram of the utility model when its placement plane is placed downwards.

FIG. 3 provides the left side elevation view of FIG. 2.

The components represented by figures in the drawings are listed below: 1: fuel tank body; 1-1: fixed plane; 1-2: placement plane; 2: outlet tube; 3: inlet tube; 4: fixed support; 5: spill-proof spacer; 5-1: arc-shaped side; 5-2: straight side; 6: fuel filler.

### DETAILED DESCRIPTION OF THE INVENTION

Drawings are used in combination to describe the principles and characteristics of the utility model; the embodiment cited is intended only to illustrate and not to limit the scope of the present utility model.

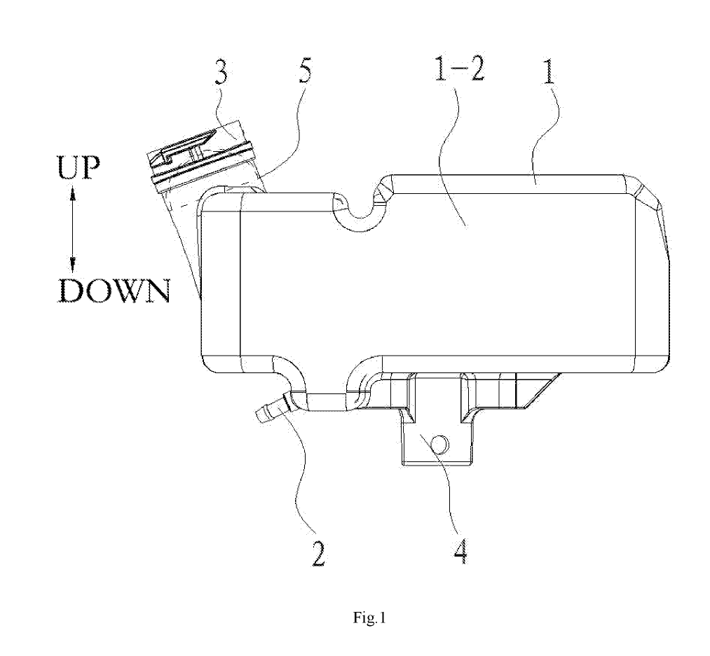

As shown in FIG. 1, the utility model includes fuel tank body 1, wherein the said fuel tank body 1 has an outlet tube 2 at the bottom; the said fuel tank body 1 has an inlet tube 3 at the top; the said fuel tank body 1 has a fixed vertical plane 1-1; the said fuel tank body 1 has a placement plane 1-2 opposite to the said fixed plane 1-1; the said fixed plane 1-1 is designed with a fixed support 4, used to fix the said fuel tank on the fuel-using equipment; the said inlet tube 3 is designed inside with a spill-proof spacer 5 on its inner wall close to the said placement plane 1-2; there is a fuel filler 6 used for filling fuel into the said fuel tank body 1 between the said spill-proof spacer 5 and the inner wall far away from the said placement plane 1-2 inside the said inlet tube 3. In the embodiment, usually the said outlet tube 2 is configured with a valve (not portrayed in the drawings), which must be closed before unloading the said fuel tank body 1, so as to avoid fuel outflow in the process of unloading the said fuel tank body 1.

In the embodiment of the utility model, there are more than three fixed supports (fixed support 4). As shown in FIG. 1 and FIG. 2, two of them extend towards the direction far away from the said placement plane 1-2, while the other extends towards the bottom; between them there are holes used for mounting bolts.

In the embodiment of the utility model, the said inlet tube 3 is set to incline towards the direction far away from the said placement plane 1-2. The top of the inlet tube 3 is set to incline towards the direction far away from the placement plane, so that, when the placement plane 1-2 of the fuel tank body 1 is placed downwards, the level of the fuel filler 6 of the inlet tube 3 will be increased to further avoid fuel outflow.

In the embodiment of the utility model, the said spill-proof spacer 5 faces one side of the said fuel filler 6, and is set to incline towards the end where the said inlet tube 3 links up with the said fuel tank body 1. Under the inclined setting of the inlet tube 3, the spill-proof spacer 5 faces one side of the fuel filler 6 and is set to incline towards the end where the inlet tube 3 links up with the fuel tank body 1. In this way, without influencing fuel filling via the fuel filler 6, when the placement plane 1-2 is placed downwards, the level of the fuel filler 6 of the fuel tank body 1 will be increased to further avoid fuel outflow.

In the embodiment of the utility model, the vertical projection of the said fuel filler 6 is outside of the vertical projection of the said fuel tank body 1, and far away from the vertical projection of the said placement plane 1-2. Given that the vertical projection of the fuel filler 6 is outside of the vertical projection of the fuel tank body 1 and far away from that of the placement plane 1-2, when the placement plane 1-2 of the fuel tank body 1 is placed downwards, fuel would not flow out of the fuel filler 6 even if the fuel tank body 1 is filled up with fuel.

As shown in FIG. 2, the said inlet tube 3 has a circular cross-section; the sides of the said spill-proof spacer 5 include arc-shaped side 5-1 and straight side 5-2; the said arc-shaped side 5-1 is fixed on the inner wall of the said inlet tube 3; the gap between the said straight side 5-2 and the inner wall of the said inlet tube 3 forms the said fuel filler 6. The inlet tube 3 has a circular cross-section, and the unit-mode side of the spill-proof spacer 5 can be perfectly sealed and linked up with the inner wall of the inlet tube 3. The said spill-proof spacer 5 and the said inlet tube 3 constitute an integrated structure. The integration of the spill-proof spacer 5 and the inlet tube 3 not only makes convenience for manufacturing of the inlet tube 3, but also avoids the failure of the spill-proof spacer 5 to block fuel outflow due to looseness.

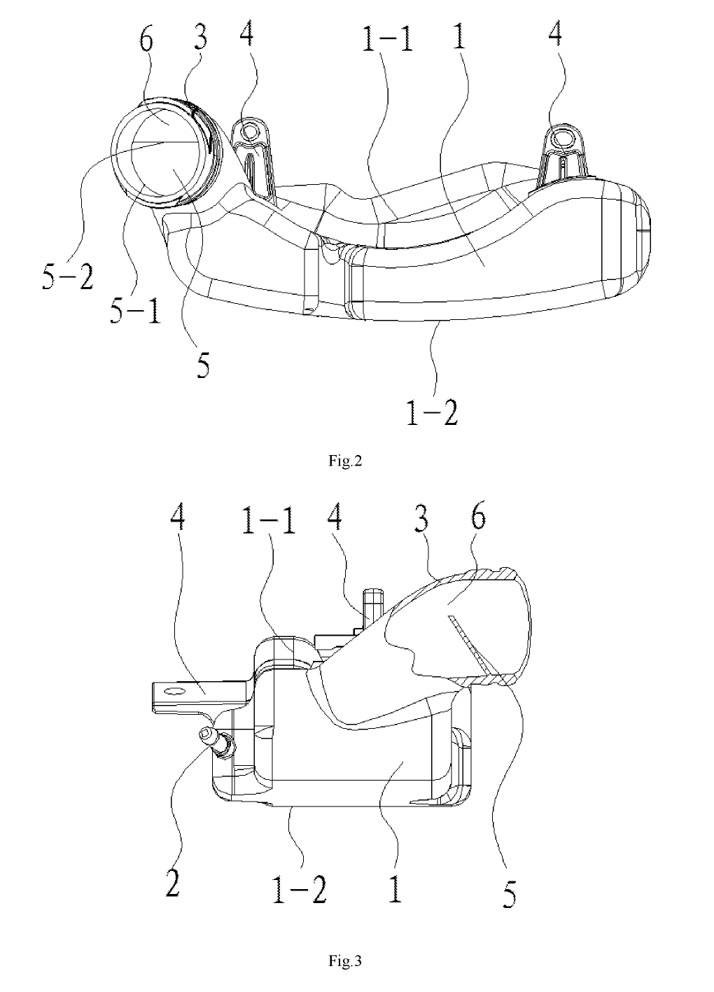

As shown in FIG. 2 and FIG. 3, after unloading the fuel tank structure of the utility model from fuel-using equipment, the placement plane 1-2 is placed downwards; at this point, the top of the inlet tube 3 is set to incline towards the direction far away from the placement plane. The spill-proof spacer 5 faces one side of the fuel filler 6 and is set to incline towards the end where the inlet tube 3 links up with the fuel tank body 1. In this state, relying on the inclined setting of the inlet tube 3 and the setting of the spill-proof spacer 5 inside the inlet tube 3, the highest level of the fuel inside the fuel tank is lower than the level of the said fuel filler 6, so fuel cannot flow out of the fuel tank body 1 via the fuel filler 6 and wasting of fuel is avoided as a result.

The utility model has a simple structure. That is, the spill-proof spacer 5 is set inside the inlet tube 3, and there is the fuel filler 6 used for filling fuel into the fuel tank body 1 between the spill-proof spacer 5 and the inner wall far away from the placement plane 1-2 inside the inlet tube 3; when the placement plane 1-2 of the fuel tank body 1 is placed downwards, the spill-proof spacer 5 can prevent fuel outflow from the fuel tank body 1 and avoid wasting of fuel.

Described above is only one preferred embodiment of the utility model, which is not intended to limit the utility model. Any and all amendments, adoption by equation, improvements and so forth made in the spirit or principles of the utility model shall be covered by the scope of protection of the utility model.

1. A safety spill-proof fuel tank structure, comprising:
a fuel tank body having n outlet tube at the bottom and an inlet tube at the top,
wherein said fuel tank body has a fixed vertical plane and a placement plane opposite to the said fixed plane,
wherein said fixed plane is comprised of a fixed support so as to fix the said fuel tank on the fuel-using equipment,
wherein said inlet tube is comprised of a spill-proof spacer inside on an inner wall close to the said placement plane, and
wherein a fuel filler filling fuel into the said fuel tank body is between the said spill-proof spacer and the inner wall far away from said placement plane inside said inlet tube.

2. The safety spill-proof fuel tank structure according to claim 1, wherein said inlet tube is set to incline towards the direction far away from the said placement plane.

3. The safety spill-proof fuel tank structure according to claim 2, wherein said spill-proof spacer faces one side of said fuel filler, and is set to incline towards the end where said inlet tube links up with said fuel tank body.

4. The safety spill-proof fuel tank structure according to claim 1, wherein a vertical projection of the said fuel filler is outside of a vertical projection of said fuel tank body, and far away from the vertical projection of said placement plane.

5. The safety spill-proof fuel tank structure according to claim 1, wherein said inlet tube has a circular cross-section, wherein sides of said spill-proof spacer is comprised of an arc-shaped side and straight side, wherein said arc-shaped side is fixed on the inner wall of said inlet tube, and wherein a gap between said straight side and the inner wall of the said inlet tube forms said fuel filler.

6. The safety spill-proof fuel tank structure according to claim 1, wherein said spill-proof spacer and said inlet tube constitute an integrated structure.
